(19) United States
(12) Patent Application Publication
(10) Pub. No.: US 2019/0234212 A1
(43) Pub. Date: Aug. 1, 2019

(54) BIT TIP INSERT

(71) Applicant: The Sollami Company, Herrin, IL (US)

(72) Inventor: Phillip Sollami, Herrin, IL (US)

(73) Assignee: The Sollami Company, Herrin, IL (US)

(21) Appl. No.: 15/960,728

(22) Filed: Apr. 24, 2018

Related U.S. Application Data
(63) Continuation-in-part of application No. 15/923,051, filed on Mar. 16, 2018.
Application No. 15/923,051 is a continuation-in-part of application No. 14/676,364, filed on Apr. 1, 2015, now Pat. No. 9,976,418.
(60) Provisional application No. 61/974,064, filed on Apr. 2, 2014.

(51) Int. Cl. E21C 35/183; E02F 9/28; B28D 1/18

(52) U.S. Cl. CPC E21C 35/183; E01C 23/088; B28D 1/186; E02F 9/2808

(57) ABSTRACT

An improved diamond coated bit tip insert for a unitary bit/holder, tool, and/or pick for road milling operations that includes a body including a tip and a base subjacent to the tip. The tip of the bit tip insert includes a substrate and an overlay on an outer surface of the substrate. The base of the bit tip insert includes a tapered sidewall or a cylindrical sidewall, the tapered sidewall providing a greater concentration of force applied at an interface of the overlay and the substrate of the tip during a high pressure high temperature (HPHT) process than when using the cylindrical sidewall and the high pressure, high temperature process.

### CROSS-REFERENCE TO RELATED APPLICATION(S)

This application claims priority to and is a continuation-in-part of U.S. Provisional Application No. 61/974,064, filed Apr. 2, 2014, claims priority to and is a continuation-in-part of U.S. Non-provisional application Ser. No. 14/676,364, filed Apr. 1, 2015, and claims priority to and is a continuation-in-part of U.S. Non-provisional application Ser. No. 15/923,051, filed Mar. 16, 2018, to the extent allowed by law and the contents of which are incorporated herein by reference in their entireties.

### TECHNICAL FIELD

This disclosure relates to improved bit/bit holder combinations and, more particularly, to such a combination utilizing a diamond layered and/or coated generally conical tip insert.

### BACKGROUND

As basic infrastructure created in the 20th Century ages and wears, machinery for rejuvenating or replacing that infrastructure has become more important. While mining and trenching operation machinery may be included in this technology, road milling machinery, down hole tools in the oil well industry, and other similar industries area, thus far, the most prolific use of the instant machinery.

Road milling equipment utilizes a rotating drum having a plurality of bit assemblies removably mounted on the outside of the drum in spiral or chevron orientation. A typical rotating drum has a bit tip to bit tip diameter of between 42 and 54 inches and includes a plurality of mounting blocks generally secured thereto by welding in spiral or chevron patterns. The patterns noted provide for the bit blocks to be mounted behind and slightly axially to the side of one another such that the bits or combination bit/holders mounted in each bit block may have the tips of the bits positioned in close proximate relation along the axial length of the drum. As such, adjacent bit tips may be positioned anywhere from about 0.200 inch to about ⅝ inch axially apart for either removing concrete, asphalt, or the like, when replacing one or both of the pavement and underlayment for roadways, or may be positioned axially closer together, about 0.200 inch, for micro milling the surface of pavement to remove buckles, create grooves on curved surfaces such as cloverleafs, or the like.

Improvements in the bits and bit/holders that are removably mounted on the bit blocks have increased the useful in-service life of those removable parts. While such bit and bit/holders have been made of steel and hardened materials such as tungsten carbide, the use of diamond coated tips and man-made PCD (polycrystalline diamond) tips, has been shown to increase the in-service life of those bits and bit/holders.

Another improvement in bit/holders has been the invention of quick change holders that have eliminated the necessity of securing such holders with threaded nuts or retaining clips and have utilized the compressive elastic ductility of hardened steel to provide sufficient radial force between the holders and the bit block bores to retain holders mounted in their respective bit block bores during operation. While such bit assemblies have included rotatable and removable bits mounted in bit holders which, in turn, were mounted in bit blocks as noted above, the introduction of diamond materials on bit tips has increased their in-service life 40 to 80 times and has, in some cases, allowed for the combining of bits and bit holders into a unitary construction with the tips no longer being rotatable on the holders.

A need has developed for improved structure at the front leading end or tip end of bit/holders that provide for improved wear characteristics, in-service life and finer milled road surfaces at reduced total cost.

### SUMMARY

This disclosure relates generally to bit and/or pick assemblies for road milling, mining, and trenching equipment. One implementation of the teachings herein is a bit tip insert that includes a body including a diameter of at least five-eighths inch at a widest part of the body, the body including a tip including a substrate and an overlay on an outer surface of the substrate; and a base subjacent the tip, the base including a tapered sidewall.

In another implementation of the teachings herein is a bit tip insert that includes a body including a diameter of at least five-eighths inch at a widest part of the body, the body including a tip including a substrate and an overlay on an outer surface of the substrate; and a base subjacent the tip, the base including a cylindrical sidewall.

These and other aspects of the present disclosure are disclosed in the following detailed description of the embodiments, the appended claims and the accompanying figures.

### BRIEF DESCRIPTION OF THE DRAWINGS

The features of the present disclosure which are believed to be novel are set forth with particularity in the appended claims. The disclosure may best be understood from the following detailed description of currently illustrated embodiments thereof taken in conjunction with the accompanying drawings wherein like numerals refer to like parts, and in which:

FIG. 1 is a front elevational view of a first embodiment of a bit/holder constructed in accordance with the present disclosure including a first embodiment of an improved and enlarged leading tip section;

FIG. 2a is a cross section view of a prior art 0.565 inch PCD tip insert mounted on a recess in a pick bolster;

FIG. 2b is a fragmentary cross section view of the 0.75 inch diameter PCD layered tip insert as in FIG. 1 shown for comparison purposes with the prior art disclosed on the other FIG. 2 drawings;

FIG. 2c is a diagram view showing the prior art tip of FIG. 2a superimposed on the front portion of the enlarged tip of FIG. 2b;

FIG. 2d is a fragmentary photograph of another prior art tip having a 0.565 inch diameter conical distal end;

FIG. 3 is a front elevational view of a second embodiment of a bit/holder constructed in accordance with the disclosure showing a second embodiment of a tip having a slight reverse taper in the aft or body portion thereof which is mounted on the front of the holder portion thereof;

FIG. 4 is a photograph showing a front elevational view of a prior art bit/holder after substantial in-service use showing the wear characteristics on it after substantial use;

FIG. 5 is a photograph showing a side elevational view of the prior art bit/holder shown in FIG. 4 wherein separated material has flowed past the left side of the bit/holder in use;

FIG. 6 is an enlarged diagrammatic elevational detail view of a third embodiment of the enlarged tip insert;

FIG. 7 is a diagrammatic stop motion side view of the partial sweep of a bit assembly as it moves through its material separating operation;

FIG. 8 is a diagrammatic front view taken at 90 degrees to FIG. 7 showing the added side overlap of successive bit assemblies resulting in a finer finish cut using a drum with standard 0.625 inch center-to-center tip spacing;

FIG. 9 is a side elevation view of a fourth embodiment of a tip insert in accordance with implementations of this disclosure;

FIG. 10 is a side elevation view of a fifth embodiment of a tip insert in accordance with implementations of this disclosure; and

FIG. 11 is a side elevation view of a sixth embodiment of a tip insert in accordance with implementations of this disclosure.

### DETAILED DESCRIPTION

The diameter of the base of the PCD ballistic insert is determined by the required geometric profile of the forward end of the point attack tool. As the machine or equipment size diminishes, so does the amount of horsepower of the engine or the machine needed to operate the machine.

The ballistic or parabolic style profile of the tip of the PCD insert provides a longer conic tip than a standard straight line side profile of a frustoconical tip. The longer parabolic tip has a greater PCD coated length with more structural strength. The included angle of the tip varies axially. Sollami PCD tool is 180 degrees indexable to achieve extended life over prior art diamond coated tools, while maintaining nearly exactly the same cut surface profile.

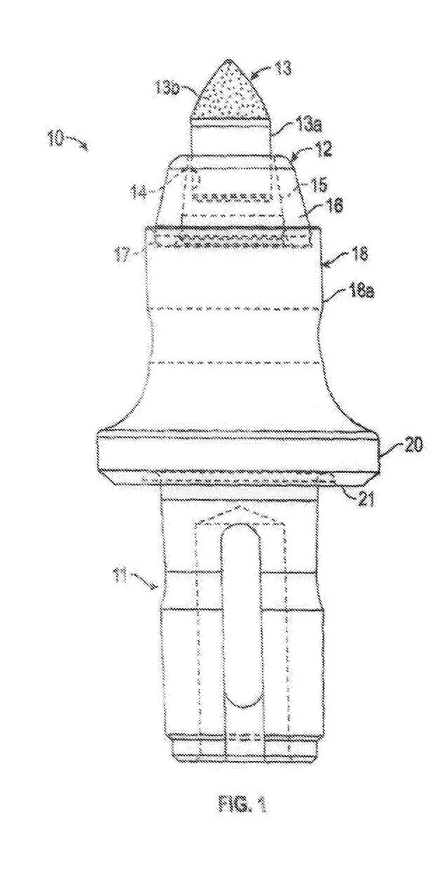

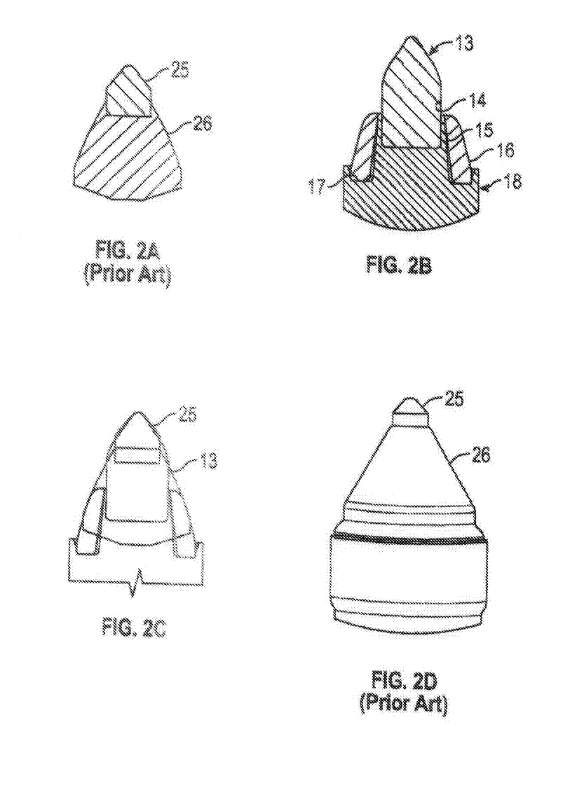

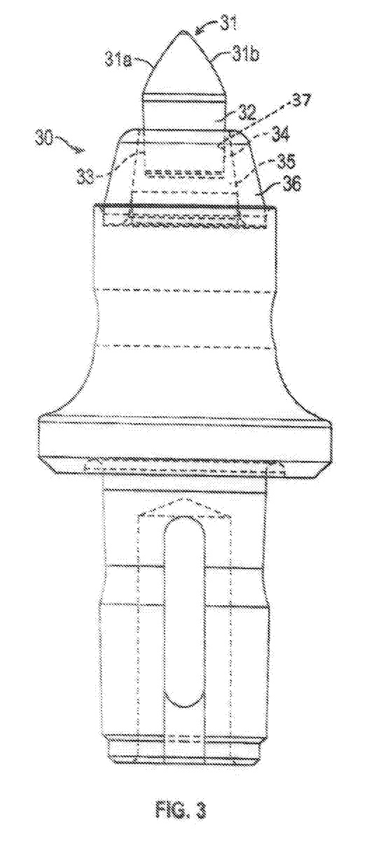

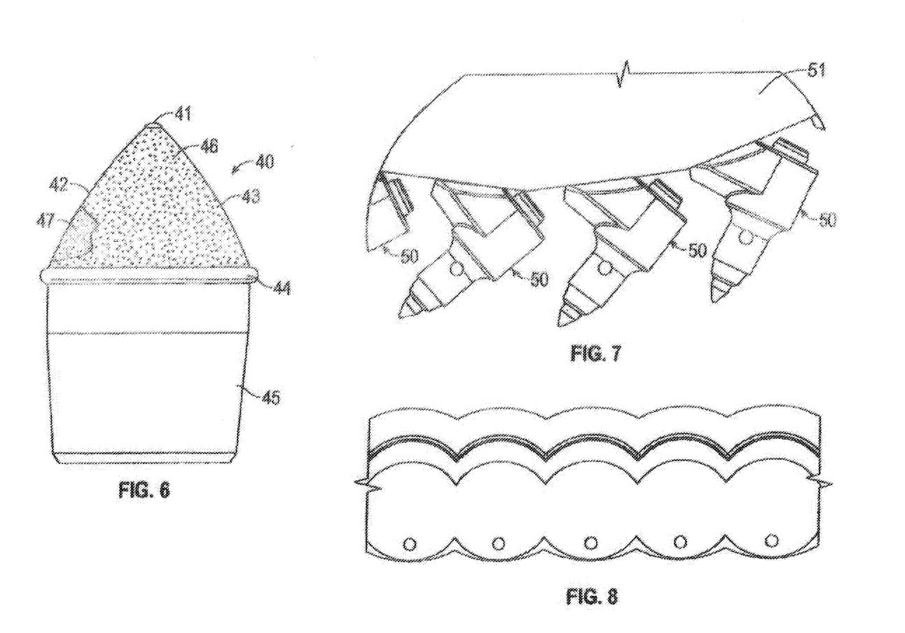

Referring to FIGS. 1 and 2, a first embodiment of a bit/holder 10, constructed in accordance with the present disclosure, includes features from this inventor's previous U.S. Pat. Nos. 6,371,567, 6,585,326 and 6,739,327 which show both the shank 11 at the rear of the bit/holder and the forward end 12 of the bit/holder 10 having a diamond coated tungsten carbide tip insert 13 mounted in a generally cylindrical recess 14 at the center of an annular flange 15 extending axially outwardly from the steel body portion of the bit/holder. This steel annular flange 15 provides ductility and shock absorption characteristics to the generally ballistic shape tip 13 that is preferably made of tungsten carbide having either a single 13b or multiple layer (See FIG. 6) of industrial diamond or PCD superstructure over the forward conical portion of the tip. Additionally, an annular ring 16 of tungsten carbide is mounted over the steel annular flange 15 for added wear resistance to the aft portion of holder. The tungsten carbide annular ring 16 is preferably brazed in an annular groove 17 at the top of the body portion 18 of the holder 10.

In the illustrated embodiment of the bit/holder 10 when used for road milling purposes, the nominal outer diameter of the shank 11 is about 1.5 inches and the nominal outer diameter of the widest portion of the body 18 of the holder is about 2⅝ inches at what is termed the “tire portion” 20 of the holder body 18. The diameter of the upper cylindrical portion 18a of the body 18 is about 1¾ inches and the axial length of the body from the rear annular flange 21 to the front of the cylindrical portion is about 3 inches. The length of the shank 11 in the embodiments shown approximates 2½ inches. As taught in my U.S. Provisional Patent Application No. 61/944,676, filed Feb. 26, 2014, now U.S. Non-provisional patent application Ser. No. 14/628,482, filed Feb. 23, 2015, and now U.S. Patent Application Publication No. 2015/0240634, published Aug. 27, 2015, the contents of which are incorporated by reference, bit holder shanks may be shorter, on the order of 1½ inches.

With the forward cylindrical end of a bit holder body 18 having a diameter of about 1¾ inches, prior art bits or pick bolsters have been designed to have a conical surface aiding in diverting pavement material away from the forward tip portion of the bit/holder or bit.

In designing these structures, tip inserts having a front conical tip of PCD or diamond layered material 13b, as shown in FIG. 1, have been selected to provide best results. The diameter of the tip insert at its widest point for holders sized as above has thus far been a tip insert made to a base diameter of about 0.565 inch. In experimenting with such diamond covered tip insert structures, applicant has discovered that using such a tip having a nominal diameter of 0.625, 0.75, 0.875 inch or larger ballistic tip insert may still be inserted in a modified structure substantially similar to that previously shown in U.S. Pat. No. 6,739,327. Thus, the improvement is also compatible with existing drums and bit holder blocks. This illustrated ¾ inch or larger diameter ballistic shaped tip insert 40 is also longer (See FIG. 6) in overall length than the 0.565 inch diameter prior insert utilized.

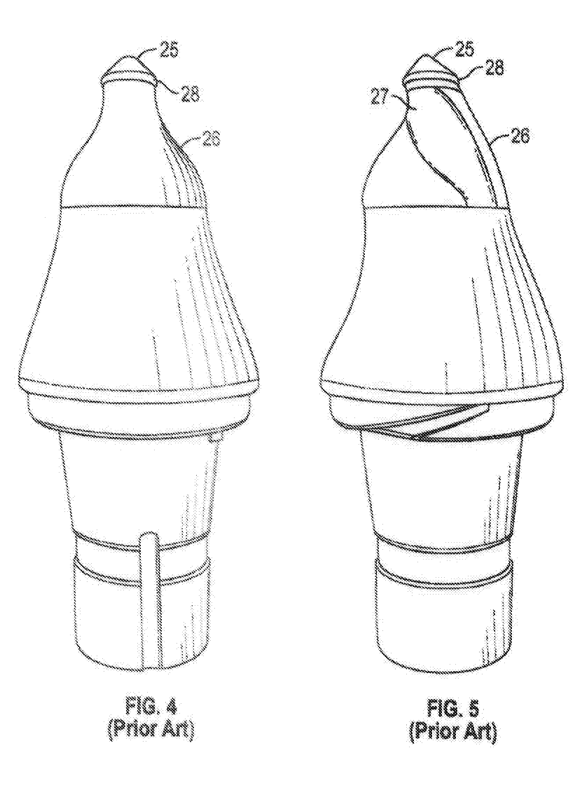

The overall length of the ¾ inch diameter ballistic tip insert is about 1⅛ inches. This length when mounted in the cylindrical recess 14, having a diameter of at least 0.625 inch, at the front of the bit holder body 18 allows the ballistic tip insert 13 to extend at least ⅝ inch from the front of the annular tungsten carbide collar 16 and to extend at least ½ inch outwardly of recess 14. When coating tungsten carbide inserts with diamond, high temperature, high pressure presses are used. Making more 0.565 diameter inserts has thus far yielded slightly cheaper inserts, but applicant has found that making fewer, larger inserts per manufacturing operation at cycle yields better milling results, although each insert is made at a slightly higher cost. Referring to FIGS. 4 and 5, the wear pattern of a prior art PCD insert tip 25 attached to a tungsten carbide bolster bit/holder 26 of prior art 0.565 inch tip diameter is shown. The conical portion of the ballistic tip insert 25 shows some wear after substantial use of the tool. Most of the wear occurs immediately aft 27 of the widest part 28 of the tip insert. This wear occurs in the product shown on both sides in FIG. 4 and on the left (loosened material flow side in FIG. 5) in what is termed a “tungsten carbide bolster” 26 that initially is generally frustoconical in shape with a slightly convex worn outer surface. The right side of the tip 25 in FIG. 5 slides along the remaining roadway material. As shown in FIGS. 4 and 5, this PCD conical front tip 25 extends minimally away from the front of the tungsten carbide bolster 26. It is submitted that the additional ⅝ inch extension of the improved ¾ inch or larger diameter ballistic tip insert of the present disclosure urges removed asphalt and concrete material away from the tip 13 at the area of most wear (the left side of FIG. 5 in the prior art) and thus provides reduced wear on the annular ring.

Referring to FIGS. 2a, 2b, 2c and 2d, the bit tip insert 13 of the disclosure shown in FIG. 2b is compared with prior art 0.565 inch diameter conical tips shown in FIG. 2a. The added diamond coated conical area of the new tip 13 of FIG. 2b, shown in FIG. 2c solid line 13 at the sides of the prior art tip of FIG. 2a at 25, provides substantially greater diamond protected cutting area than the prior art. This added area, when used on neighboring like sized tips, on ⅝ inch center-to-center drums, provides substantial cutting overlap on pavement to be milled.

FIGS. 2a and 2d show prior art 0.540 to 0.565 inch PCD inserts 25 which have conical PCD tips brazed to tungsten carbide bases mounted on a pick bolster 26 made of tungsten carbide.

FIG. 2c shows the outlines of tip insert 13 of the present disclosure as mounted in a bit holder with the prior art 0.565 tip and bolster of FIG. 2a superimposed at 25 thereon. As in FIG. 2b, the added (enlarged) diamond coated conical portion over this piece of prior art can readily be seen with similar advantages as discussed above. The profiles toward the top of the bit insert are similar, but the height of the tapered portion is greater than a 0.565 inch PCD tip producing better wear protection to the annular carbide ring as will be discussed below.

FIG. 2d shows another prior art 0.565 diamond tip insert 25. Applicant's 0.75 inch conical tip insert would provide similar advantages over this tip as mentioned in connection with FIG. 2c above.

FIG. 3 shows a second embodiment of a bit/holder 30 of the present disclosure utilizing a 0.75 inch nominal diameter diamond covered conical tip 31 with a tungsten carbide base 32 that is slightly reverse tapered at its sides 33, 34 at approximately a 2 degree half angle in this illustrated embodiment, that is, 2 degrees per side. In other embodiments, the tungsten carbide base 32 is slightly reverse tapered at its sides 33, 34 in the range of and including 1/100 of 1 degree to 15 degrees per side).

While prior art bits and bit/holders disclose an enlarged tungsten carbide conical portion just aft of the 0.565 inch base insert with PCD shaped tip, the present disclosure, having a steel annular tubular column 35 having a recess 37 (FIG. 3) into which the 0.75 diameter PCD insert 31 is inserted, provides additional shock absorbing characteristics as a result of the ductility of the steel and subjacent braze joint. Prior art PCD tungsten carbide inserts brazed to tungsten carbide bases do not possess those shock absorbing capabilities. The central steel annular tubular column 35 also provides for greater thermal expansion and contraction during use. As the forward end of the PCD insert 31 increases its working temperature, the steel column 35 and the braze joint will expand about twice the amount of tungsten carbide expansion for the same increase in temperature and radially grab the PCD insert 31 more securely. The carbide collar 36 restricts the steel column 35 from similarly expanding outwardly. The steel tubular column 35 has about twice the coefficient rate of thermal expansion value as tungsten carbide.

Thus, improved bit/holders 10, 30, utilizing a ballistic shape tip of an increased diameter from 0.565 inch to 0.75 inch and larger provides a superior product than previously known in the art while still being usable with present size bit holder blocks (not shown).

Referring to FIG. 6, a third embodiment of a ballistic shaped diamond coated tungsten carbide insert 40 is shown. A tip such as shown in the first embodiment could include a frustoconical tip having an approximately ⅛ inch curved radius at the top 41 thereof, and straight or parabolic conical sides leading down to the widest part of the base 44. Also, the tip 13 shown in the first embodiment has a cylindrical base 13a that extends at least about ¾ inch behind the generally conical tip 13, which fits into the cylindrical recess 14 at the top of the body 18 of the holder 10 in the first embodiment and is brazed into recess 14.

In the second embodiment of the bit/holder 30, the tip 31 shown in FIG. 3 and the third embodiment of the tip 40 of FIG. 6 also include an approximate ⅛ inch curved top. The sides 31a, 31b (FIG. 3) of the conical portion of the insert are parabolic in shape. An additional ⅛ inch thereafter, the parabola shape changes to a 60½ degree separation and another ⅛ inch down from there the separation changes to an approximate 51 degree separation.

The parabolic shape of the ballistic tip 31 provides more mass under the multi layered diamond coating than would a straight side conical tip. Additionally, the top of the parabolic tip 31 provides improved separation of the material removed from the base thereof and directs the material removed further away from the base of the tip.

As shown, the base 32 of the tip 31 in the second embodiment is ¾ inch in diameter and in the second embodiment includes a 2 degree per side taper toward the bottom of the insert which is about a total 1 inch to 1.5 inches in height.

As mentioned previously, it appears from the drawing shown in FIG. 3, that an important factor for wear in the bit/holder is the width of the base of the tip in the insert. While prior art inserts have been approximately 0.565 inch in diameter, increasing that diameter to 0.75 inch and larger provides a wider base at the point of greatest wear during use of such a bit/insert. Thus the use of a 0.75 inch or greater diameter insert base provides for greater longevity of use. Also, larger bit holders are utilized for trenching and mining operations, so larger bit inserts can be utilized there. Further, the increased length of the insert to 1 inch in length or greater allows at least a ⅝ inch exposed length of the insert that also directs material removed away from the base of the insert to decrease the wear in what FIGS. 4 and 5 show as the most sensitive part of the wear for a bit/holder during use.

The third embodiment of the diamond coated tip 40 shown in FIG. 6 differs from that shown in FIG. 3 in that the diamond coating 46 includes a ridge or overfill portion 44 at the base of the parabolic curves 42, 43 that has a thickness of about 0.010 inch or more per side. The overfill or over formed portion 44 may not be regular in shape and does not need to be ground or removed into any specific shape. This added diameter also affects the shape of the finished surface as will be discussed in more detail below. Depending upon the grade of diamond material or PCD material used, this thickness of the diamond coating may typically be about 0.120 inch or less. Multiple layers of diamond coating 46, 47, as shown in FIG. 6, may be overlayed on the bit tip 40. It should be noted that with the greater diameter and outward extending diamond edge overfill 44 of the increased tip 40 shown in FIG. 6, a thinner diamond or PCD coating at 46, 47 may be utilized in adjusting wear characteristics vs. cost. It should be noted that the conical area of a 0.75 inch diameter cone at the tip includes over 3.5 times the area of a 0.565 inch tip, providing a substantially more massive cutting tool.

Referring to FIGS. 7 and 8, a plurality of cutting tools 50-50, constructed in accordance with the present disclosure, are shown sweeping across the cutting area of a surface to be removed. As previously described, the increased outer diameter of the bit tip to 0.75 inch adds mass to the exact area where most wear during use occurs. This increased cross section creates a shallow depth pattern as needed in micro milling, without requiring additional machine horsepower.

As previously discussed, a plurality of these bit assemblies 50-50 are mounted on cylindrical drum 51 in spiral or chevron fashion. A typical drum being about 7 feet to about 13 feet in length and typically 42 to 54 inches in diameter, may hold around 168 to 650 bit assemblies with center-to-center axial spacing of 0.625 inch between bit assemblies. This is in what is termed a “standard drum” previously used for removal of not only surface material, but also substrate material. Previously, drums used for micro milling have had center-to-center tip axial spacing of 0.20 inch between tips. As such, drums used for micro milling may have about 325 bit assemblies for same 7 feet 2 inch length drum. This is in drums term “double or triple hit drums,” double hit drums may have about 25 percent more of the bit assemblies. Full lane micro milling drums that are about 13 feet in length may have 600 to 900 bit assemblies per drum at a 0.200 inch center-to-center axial tip spacing.

Applicant has found that the use of ¾ inch nominal diameter or larger diamond coated bit tips when used at ½ to 1 inch depth of cut at approximately 92 rpm drum rotation speed and at a travelling speed of 20-40 ft/min may provide a surface approaching or equal to the flatness of a micro milled surface previously obtained with 0.565 inch diameter bit tips on drums having 0.200 inch center-to-center bit separation with same machine cutting specifications.

FIG. 8 shows a diagram of succeeding 0.75 inch bit tips of the present disclosure spaced at 0.625 inch apart which gives an axial overlap between adjacent bit tips of about 0.125 inch. This overlap is also at the point of most vertical curvature for even a ½ inch depth of the cut, leaving a substantially flatter surface than would be obtained using the 0.565 inch diameter bit tips. The fineness of the residual surface is also obtained by moving the drum at a slower speed (15-25 fpm). The faster in feet per minute the drum travels forward, the rougher the cut. It is therefore necessary not to outrun the cut. A speed of 60-120 feet per minute is considered normal for a rough cut.

As noted, the resulting fineness of the surface milled using the larger diameter bit tip approaches or achieves micro milling flatness by utilizing standard center-to-center diameter drums instead of the more expensive drums presently made for micro milling operations. Additional fineness of cut can be achieved by modifying spacing to somewhat less than 0.625, but substantially greater than 0.2 inch center-to-center. Not only is the cost of the drum less, but utilizing fewer bit assemblies makes a lighter drum requiring less horsepower to operate with more fuel efficiency and less impact on the machine components.

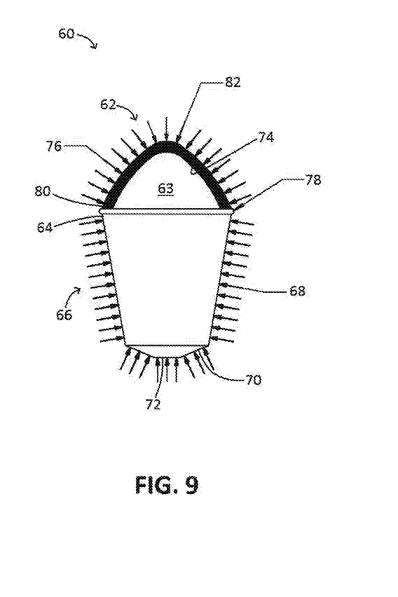

Referring to FIG. 9, a fourth embodiment of a tip insert 60 of the present disclosure is shown. The tip insert 60 comprises a generally conical tip 62 at a forward end 64 of a base 66 that includes a parabolic curved section below an apex of the tip insert 60. The tip 62 can also have a frustoconical shape, a flat generally cylindrical puck shape, a parabolic ballistic shape, and/or an arcuate shape. In one exemplary implementation of the fourth embodiment, the tip insert 60 can have a diameter in the range of ⅝ inch to 1.250 inch. The base 66 comprises a complementary shaped declining tapered outer surface or sidewall 68 that is adapted to be mounted in a complementary shaped forward end of a unitary bit/holder, tool, and/or pick. In this fourth embodiment, the base 66 includes a frustoconical portion 70 adjacent a distal end 72 of the base 66. The outer surface 68 may require grinding or other additional finishing processes, while the frustoconical portion 70 and the distal end 72 of the base 66 do not require additional finishing processes, such as grinding. The base 66 may be made of steel or tungsten carbide and includes the tip 62 at the outer or forward end 64 of the base 66. In this embodiment, the base 66 is made primarily of tungsten carbide and the tip 62 comprises a substrate 63 that is primarily made of tungsten carbide. As described in Applicant's U.S. Pat. No. 6,199,451, powdered tungsten carbide and a powdered binder, such as cobalt or nickel, which are premixed together, are compacted within a generally tubular die by punches pressing against the tip 62 and the base 66 which forms a finished tungsten carbide component that includes the tip profile. The forces which compress the particles of powdered tungsten carbide are exerted perpendicular to the surfaces of the tip 62 and base 66, as shown by the various arrows.

An overlay 76 of a polycrystalline diamond structure is placed on an outer surface or forward end 74 of the tip 62 of the finished tungsten carbide component. The overlay 76 may also be made of an industrial diamond material and may include a single coating or outer layer or multiple coating or outer layers of such industrial diamond material, natural diamond, polycrystalline diamond (PCD) material, and polycrystalline diamond composite and/or compact (PDC) material. The single or multiple coatings or layers of the overlay 76 may be formed by a high pressure, high temperature (HPHT) process. The finished tungsten carbide component, which includes the tip 62 and the base 66, and the overlay 76 on the forward end 64 of the tip 62 are centered and placed in a can or metal enclosure and a plurality of hydraulic pistons apply pressure and force on the can over time during the HPHT process, compressing and/or pressing the tip 62 and base 66 again. The HPHT process liquefies the binder material, such as cobalt in this embodiment, which migrates toward the overlay 76 and binds to the diamond and tungsten carbide producing a stronger form. The diamond to diamond bond in the overlay 76 and tip 62 is created by the catalytic attachment of the cobalt within the small cavities of diamond crystals in the overlay 76.

During the HPHT process, excess PCD material 78 forms a bulge or small flash between a distal end 80 of the tip 62 and the forward end 64 of the base 66. The excess PCD material 78 can be used as formed on tools that are used in milling, trenching, mining, and similar applications. The overlay 76 occupies a large radial and axial profile of the tip 62 which allows faster heat transfer into a region subjacent to the overlay 76 PCD layer. Excessively high heat, such as temperatures above 1300 degrees F., is the greatest cause of PCD failure due to diamond connective failure, the quick heat transfer from the tip 62 of the PCD cutting zone to the subjacent region below the PCD drastically reduces the possibility of a temperature of the tip 62 of the PCD reaching temperatures at or above 1300 degrees F. for any extended period of time thereby avoiding failure of the PCD layer. Furthermore, a tapered base sidewall, such as the tapered outer surface 68 of base 66, on a PDC insert provides a greater concentration of forces applied at the forward PCD overlay 76 and tungsten carbide interface in tip 62 than when using a cylindrical, non-tapered base sidewall and the HPHT process. All external forces 82 are applied at right angles to the tapered outer surface of the tip insert 60, which depends on the vector force directed axially towards the tip 62.

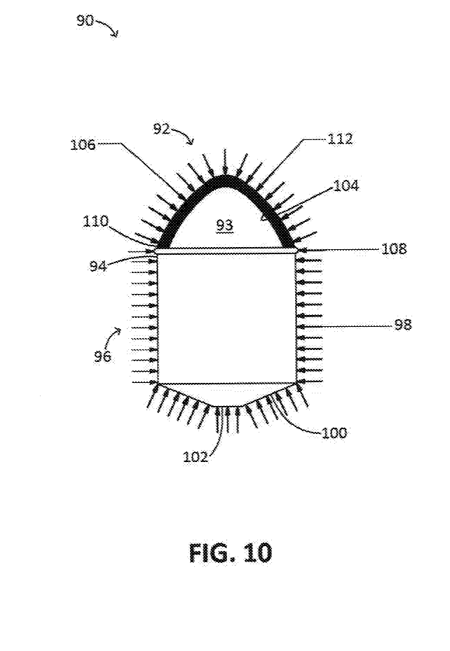

Referring to FIG. 10, a fifth embodiment of a tip insert 90 of the present disclosure is shown. The tip insert 90 comprises a generally conical tip 92 at a forward end 94 of a base 96 that includes a parabolic curved section below an apex of the tip insert 90. The tip 92 can also have a frustoconical shape, a flat generally cylindrical puck shape, a parabolic ballistic shape, and/or an arcuate shape. In one exemplary implementation of the fifth embodiment, the tip insert 90 can have a diameter in the range of ⅝ inch to 1.250 inch. The base 96 comprises a complementary shaped cylindrical outer surface or sidewall 98 that is adapted to be mounted in a complementary shaped forward end of a unitary bit/holder, tool, and/or pick. In this fifth embodiment, the base 96 includes a frustoconical portion 100 adjacent a distal end 102 of the base 96. The outer surface 98 may require grinding or other additional finishing processes, while the frustoconical portion 100 and the distal end 102 of the base 96 do not require additional finishing processes, such as grinding. The base 96 may be made of steel or tungsten carbide and includes the tip 92 at the outer or forward end 94 of the base 96. In this embodiment, the base 96 is primarily made of tungsten carbide and the tip 92 comprises a substrate 93 that is primarily made of tungsten carbide. Powdered tungsten carbide and a powdered binder, such as cobalt or nickel, which are premixed together, are compacted within a generally tubular die by punches pressing against the tip 92 and the base 96 which forms a finished tungsten carbide component that includes the tip profile. The forces which compress the particles of powdered tungsten carbide are exerted perpendicular to the surfaces of the tip 92 and base 96, as shown by the various arrows.

An overlay 106 of a polycrystalline diamond structure is placed on an outer surface or forward end 104 of the tip 92 of the finished tungsten carbide component. The overlay 106 may also be made of an industrial diamond material and may include a single coating or outer layer or multiple coating or outer layers of such industrial diamond material, natural diamond, polycrystalline diamond (PCD) material, and polycrystalline diamond composite and/or compact (PDC) material. The single or multiple coatings or layers may be formed by a high pressure, high temperature (HPHT) process. The finished tungsten carbide component, which includes the tip 92 and the base 96, and the overlay 106 on the forward end 104 of the tip 92 are centered and placed in a can or metal enclosure and a plurality of hydraulic pistons apply pressure and force on the can over time during the HPHT process, compressing and/or pressing the tip 92 and base 96 again. The HPHT process liquefies the binder material, such as cobalt in this embodiment, which migrates toward the overlay 106 and binds to the diamond and tungsten carbide producing a stronger form. The diamond to diamond bond in the overlay 106 and tip 92 is created by the catalytic attachment of the cobalt within the small cavities of diamond crystals in the overlay 106.

During the HPHT process, excess PCD material 108 forms a bulge or small flash between a distal end 110 of the tip 92 and the forward end 94 of the base 96. The excess PCD material 108 can be used as formed on tools that are used in milling, trenching, mining, and similar applications. The overlay 106 occupies a large radial and axial profile of the tip 92 which allows faster heat transfer into a region subjacent to the overlay 106 PCD layer. Excessively high heat, such as temperatures above 1300 degrees F., is the greatest cause of PCD failure due to diamond connective failure, the quick heat transfer from the tip 92 of the PCD cutting zone to the subjacent region below the PCD drastically reduces the possibility of a temperature of the tip 92 of the PCD reaching temperatures at or above 1300 degrees F. for any extended period of time thereby avoiding failure of the PCD layer. Furthermore, all external forces 112 are applied at 90 degrees to the centerline on the cylindrical sidewall 98 of the base 96 and at right angles to the outer surface of the tip 92.

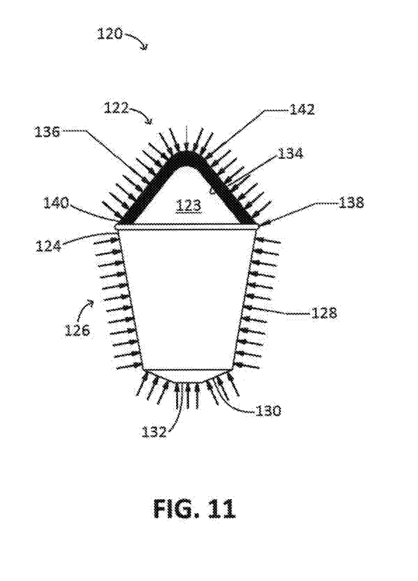

Referring to FIG. 11, a sixth embodiment of a tip insert 120 of the present disclosure is shown. The tip insert 120 comprises a generally conical tip 122 at a forward end 124 of a base 126 that includes a conical or angular section below an apex of the tip insert 120. The tip 122 can also have a frustoconical shape, a flat generally cylindrical puck shape, a parabolic ballistic shape, and/or an arcuate shape. In one exemplary implementation of the sixth embodiment, the tip insert 120 can have a diameter in the range of ⅝ inch to 1.250 inch. The base 126 comprises a complementary shaped declining tapered outer surface or sidewall 128 that is adapted to be mounted in a complementary shaped forward end of a unitary bit/holder, tool, and/or pick. In this sixth embodiment, the base 126 includes a frustoconical portion 130 adjacent a distal end 132 of the base 126. The outer surface 128 may require grinding or other additional finishing processes, while the frustoconical portion 130 and the distal end 132 of the base 126 do not require additional finishing processes, such as grinding. The base 126 may be made of steel or tungsten carbide and includes the tip 122 at the outer or forward end 124 of the base 126. In this embodiment, the base 126 is primarily made of tungsten carbide and the tip 122 comprises a substrate 123 that is primarily made of tungsten carbide. Powdered tungsten carbide and a powdered binder, such as cobalt or nickel, which are premixed together, are compacted within a generally tubular die by punches pressing against the tip 122 and the base 126 which forms a finished tungsten carbide component that includes the tip profile. The forces which compress the particles of powdered tungsten carbide are exerted perpendicular to the surfaces of the tip 122 and base 126, as shown by the various arrows.

An overlay 136 of a polycrystalline diamond structure is placed on an outer surface or forward end 134 of the tip 122 of the finished tungsten carbide component. The overlay 136 may also be made of an industrial diamond material and may include a single coating or outer layer or multiple coating or outer layers of such industrial diamond material, natural diamond, polycrystalline diamond (PCD) material, and polycrystalline diamond composite and/or compact (PDC) material. The single or multiple coatings or layers may be formed by a high pressure, high temperature (HPHT) process. The finished tungsten carbide component, which includes the tip 122 and the base 126, and the overlay 136 on the forward end 134 of the tip 122 are centered and placed in a can or metal enclosure and a plurality of hydraulic pistons apply pressure and force on the can over time during the HPHT process, compressing and/or pressing the tip 122 and base 126 again. The HPHT process liquefies the binder material, such as cobalt in this embodiment, which migrates toward the overlay 136 and binds to the diamond and tungsten carbide producing a stronger form. The diamond to diamond bond in the overlay 136 and tip 122 is created by the catalytic attachment of the cobalt within the small cavities of diamond crystals in the overlay 136.

During the HPHT process, excess PCD material 138 forms a bulge or small flash between a distal end 140 of the tip 122 and the forward end 124 of the base 126. The excess PCD material 138 can be used as formed on tools that are used in milling, trenching, mining, and similar applications. The overlay 136 occupies a large radial and axial profile of the tip 122 which allows faster heat transfer into a region subjacent to the overlay 136 PCD layer. Excessively high heat, such as temperatures above 1300 degrees F., is the greatest cause of PCD failure due to diamond connective failure, the quick heat transfer from the tip 122 of the PCD cutting zone to the subjacent region below the PCD drastically reduces the possibility of a temperature of the tip 122 of the PCD reaching temperatures at or above 1300 degrees F. for any extended period of time thereby avoiding failure of the PCD layer. Furthermore, a tapered base sidewall, such as the tapered outer surface 128 of base 126, on a PDC insert provides a greater concentration of forces applied at the forward PCD overlay 136 and tungsten carbide interface in tip 122 than when using a cylindrical, non-tapered base sidewall and the HPHT process. All external forces 142 are applied at right angles to the tapered outer surface of the tip insert 120, which depends on the vector force directed axially towards the tip 122.

As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, “X includes at least one of A and B” is intended to mean any of the natural inclusive permutations. That is, if X includes A; X includes B; or X includes both A and B, then “X includes at least one of A and B” is satisfied under any of the foregoing instances. The articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment, aspect or implementation unless described as such.

While the present disclosure has been described in connection with certain embodiments and measurements, it is to be understood that the invention is not to be limited to the disclosed embodiments and measurements but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A bit tip insert comprising:
a body including a diameter of at least five-eighths inch at a widest part of the body, the body comprising:
a tip including a substrate and an overlay on an outer surface of the substrate; and
a base subjacent the tip, the base including a tapered sidewall.

2. The bit tip insert of claim 1, wherein the overlay comprises at least one of a polycrystalline diamond, industrial diamond, natural diamond, polycrystalline diamond composite material, and polycrystalline diamond compact material.

3. The bit tip insert of claim 2, wherein the overlay comprises at least one of:
at least one coating on the outer surface of the tip; and
at least one layer on the outer surface of the tip.

4. The bit tip insert of claim 1, wherein the overlay on the outer surface of the substrate is formed by a high pressure high temperature (HPHT) process.

5. The bit tip insert of claim 4, further comprising:
an overfill portion formed generally between the tip and the base during the HPHT process, the overfill portion extending outwardly of the widest portion of the body.

6. The bit tip insert of claim 1, wherein the tip is generally conical.

7. The bit tip insert of claim 1, further comprising:
one of a parabolic curved section and a conical section below an apex of the tip.

8. The bit tip insert of claim 1, wherein at least one of the substrate and the base is made of tungsten carbide.

9. The bit tip insert of claim 1, wherein the base includes a frustoconical portion adjacent a distal end of the base.

10. The bit tip insert of claim 1, further comprising:
an interface between the substrate and the overlay of the tip, the tapered sidewall of the base adapted to provide a greater concentration of force at the interface of the tip during a high pressure high temperature (HPHT) process that forms the overlay on the outer surface of the substrate.

11. A bit tip insert comprising:
a body including a diameter of at least five-eighths inch at a widest part of the body, the body comprising:
a tip including a substrate and an overlay on an outer surface of the substrate; and
a base subjacent the tip, the base including a cylindrical sidewall.

12. The bit tip insert of claim 11, wherein the overlay comprises at least one of a polycrystalline diamond, industrial diamond, natural diamond, polycrystalline diamond composite material, and polycrystalline diamond compact material.

13. The bit tip insert of claim 12, wherein the overlay comprises at least one of:
at least one coating on the outer surface of the tip; and
at least one layer on the outer surface of the tip.

14. The bit tip insert of claim 11, wherein the overlay on the outer surface of the substrate is formed by a high pressure high temperature (HPHT) process.

15. The bit tip insert of claim 4, further comprising:
an overfill portion formed generally between the tip and the base during the HPHT process, the overfill portion extending outwardly of the widest portion of the body.

16. The bit tip insert of claim 11, wherein the tip is generally conical.

17. The bit tip insert of claim 11, further comprising:
one of a parabolic curved section and a conical section below an apex of the tip.

18. The bit tip insert of claim 11, wherein at least one of the substrate and the base is made of tungsten carbide.

19. The bit tip insert of claim 11, wherein the base includes a frustoconical portion adjacent a distal end of the base.
